(19) United States
(12) Patent Application Publication
(10) Pub. No.: US 2004/0216153 A1
(43) Pub. Date: Oct. 28, 2004

(54) Disk chucking device and disk drive including the same

(75) Inventor: Naohide Ota, Nagano (JP)

Correspondence Address: OLIFF & BERRIDGE, PLC, P.O. BOX 19928, ALEXANDRIA, VA, 22320, US

(73) Assignee: SHINANO KENSHI CO., LTD, Nagano (JP)

(21) Appl. No.: 10/693,923

(22) Filed: Oct. 28, 2003

(30) Foreign Application Priority Data
Oct. 31, 2002 (JP) 2002-318363

(51) Int. Cl. G11B 23/00; G11B 25/00

(52) U.S. Cl. 720/703

(57) ABSTRACT

A disk chucking device for an optical disk drive includes a turn table that is rotated by a spindle motor and a chucking pulley that has a pressure contacting surface on one side thereof and at least one wall peripherally and circularly on the other side thereof, in which the pressure contacting surface forces an optical disk to come into pressure contact with and attaches the optical disk to a reference surface for disk attachment of the turn table and the wall is capable of preventing acceleration of airflow caused by centrifugal force due to rotation of the optical disk and thus reducing flow noise.

### BACKGROUND OF THE INVENTION

1. Field of the Invention

The present invention relates to a disk chucking device for an optical.disk drive. More particularly, the present invention relates to a disk chucking drive having a chucking pulley. The present invention also relates to an optical disk drive including such a disk chucking device.

2. Description of the Related Art

Conventionally, disk chucking devices having a chucking pulley for an optical disk drive have been proposed. FIGS. 10 and 11 show a conventional optical disk drive, wherein FIGS. 10 and 11 are perspective views of the conventional optical disk drive in unloading and loading states, respectively.

Referring to FIG. 10, an optical disk 1 is horizontally placed on a concave portion 3 formed at an upper side of a disk tray 2. With gently pressing a front panel 2a of the tray 2 in a direction of an arrow a₁, a loading switch (not shown in FIG. 10) is turned on so that a loading mechanism carries the optical disk 1 horizontally to a turn table coupled to a spindle motor. More particularly, the loading mechanism automatically pulls the disk tray 2 having the optical disk 1 thereon into an optical disk drive 5, through an inlet/outlet opening, in a loading direction of the arrow a₁, as shown in FIG. 11.

After loading operation of the optical disk 1, the spindle motor causes the optical disk 1 to rotate at high-speed in accordance with a command signal such as a recording or reproducing command signal issued by a host computer, and then an optical pickup unit records data on the optical disk 1 or reproduces data therefrom. After recording or reproducing operation of the optical disk 1, the disk tray 2 is caused to exit from the optical disk drive 5 through the inlet/outlet opening in an unloading direction of an arrow a₂ in accordance with an unloading instruction signal from the host computer or the like, as shown in FIG. 10.

FIG. 12 illustrates a first example of a conventional disk chucking device for an optical disk drive. In FIG. 12, the disk chucking device is generally indicated by 61. A chucking pulley, a magnet and a yoke are indicated by 63, 65 and 66, respectively. In addition, a flange, a pressure contacting surface that comes into pressure contact with the disk and a center pin of the chucking pulley are indicated by 63a, 63b and 63c, respectively. Also, in FIG. 12, an optical disk, a spindle motor, a motor shaft, a turn table, a center ring guide, a reference surface for disk attachment and a center hole are indicated by 1, 39, 39a, 40, 40a, 40b and 40c, respectively.

The optical disk is inevitably influenced by warp or twist, shown as a dashed line or a broken line in FIG. 12. In addition, the optical disk 1 produces vibration of natural vibration frequencies when the optical disk 1 rotates at high-speed. Furthermore, while data are recorded on/reproduced from the optical disk 1, the optical disk 1 is subject to vibration caused by resonance due to the rotation of the spindle motor 39, the high speed seek of a carriage included in the optical pickup unit (not shown in FIG. 12), the skew adjustment operation and so on. As the degree of warp or twist of the optical disk 1 increases or the magnitude of the natural vibration or the resonance is higher, an error of focus of a leaser beam directed to the optical disk 1 through an objective lens becomes greater to the extent that data cannot be correctly recorded on/reproduced from the optical disk 1 and that the optical disk 1 may be broken.

FIG. 13 illustrates a second example of a conventional disk chucking device for an optical disk drive. The second example of the conventional disk chucking device of FIG. 13 overcomes the drawbacks of the above first example. Such a conventional disk chucking device is disclosed in Japanese Patent Application Publication No. 1999-213495.

Referring to FIG. 13, the disk chucking device is generally indicated by 61, a disk is indicated by 1, a spindle motor is indicated by 39, a motor shaft is indicated by 39a, a turn table is indicated by 40,a disk reference face is indicated by 40b, a center hole is indicated by 40c, a chucking pulley is indicated by 63, a chucking pulley body is indicated by 63A, a pressure contacting plate that comes into pressure contact with the disk is indicated by 63B, a center pin is indicated by 63C, a magnet is indicated by 65, a yoke is indicated by 66, an engaging tooth is indicated by 67, an engaging hole is indicated by 68 and a central concave potion is indicated by 69.

The chucking pulley body 63A and the pressure contacting plate 63B are integrally formed by a nonmagnetic, high rigid material such as aluminum and engineering plastic. The pressure contacting surface 63b of the pressure contacting plate 63B is also formed by a high rigid member that has been fabricated with high precision. In the conventional disk chucking device 61, the chucking pulley 63 forces the optical disk 1 to come into pressure contact with the reference surface 40b of the turn table 40 and attaches the optical disk 1 to the reference surface 40b by magnetic attraction force between the magnet 65 and the turn table 40. Since the chucking pulley 63 is designed such that the pressure contacting surface 63b forces the optical disk 1 to come into pressure contact with the reference surface 40b against elastic force of the optical disk 1, the disk chucking device 61 is capable of correcting the warp or twist of the optical disk 1 while the disk 1 is pressed and attached to the reference surface 40b. In this way, the optical disk 1 can precisely come into pressure contact with and be attached to the reference surface 40b.

In addition, since the pressure contacting surface 63b has a diameter greater than that of the reference surface for the disks 40b, the pressure contacting surface 63b comes into pressure contact with the optical disk 1 at almost the halfway of inner and outer perimeters. Such disk chucking mechanism can precisely correct the warp or twist of the optical disk 1 so as to allow the optical disk 1 to confirm to the pressure contacting surface 63b and thus significantly improving planarity of the optical disk 1. Furthermore, while data are recorded on or reproduced from the optical disk 1, the optical disk 1 may produce the vibration of the natural vibration frequencies because the spindle motor 39 rotates the optical disk 1 at high speed. Also, the optical disk 1 is likely to be subject to the vibration caused by resonance due to the rotation of the spindle motor 39, the high speed seek of the carriage included in the optical pickup unit (not shown in FIG. 12), the skew adjustment operation and so on. Nevertheless, the disk chucking mechanism can suppress the vibration of the optical disk 1 because the large pressure contacting surface 63b of the pressure contacting plate 63B comes into pressure contact with the optical disk 1 and reduces the warp or twist of the optical disk 1.

Although, the above conventional disk chucking devices are directed to reducing the vibration of an optical disk, they do not consider flow noise above a surface of the rotating optical disk. Therefore, satisfactory flow noise reduction effect will not be achieved. FIG. 14 shows how the flow noise is generated in the conventional disk chucking device. For the purpose of simplicity, the disk chucking device similar to that of FIG. 13 is schematically shown in FIG. 14. The optical disk is indicated by 1, a top chassis that isolates an inside of the disk chucking device from an outside thereof is indicated by 11, a turn table is indicated by 40 and a chucking pulley is indicated by 63.

As a spindle motor (not shown in FIG. 14) rotates the optical disk 1, airflow is created at a center of the surface of the optical disk 1 and is radially directed to a perimeter of the optical disk 1 due to centrifugal force. This airflow will generate considerably loud flow noise when the optical disk 1 rotates at high speed. There is a need to reduce this flow noise in the disk chucking device.

### SUMMARY OF THE INVENTION

It is an object of the present invention to provide a disk chucking device for an optical disk drive in which flow noise due to rotation of an optical disk can be reduced and the above disadvantages are eliminated.

It is a further object of the present invention to provide an optical disk drive having a disk chucking device capable of reducing flow noise due to rotation of an optical disk.

The objects of the present invention are achieved by a disk chucking device for an optical disk drive, the disk chucking device comprising: a turn table that is rotated by a spindle motor; and a chucking pulley that has a pressure contacting surface on one side of the chucking pulley, the pressure contacting surface forcing an optical disk to come into pressure contact with and attaching the optical disk to a reference surface of the turn table, wherein the chucking pulley has at least one wall that is provided on the other side of the chucking pulley and is arranged along a circumferential periphery of the chucking pulley.

The above-mentioned wall functions to prevent the acceleration of the airflow caused by the centrifugal force due to rotation of the optical disk so that the wall can intercept the airflow and stop the acceleration of the airflow, otherwise the flow rate thereof would be accelerated as the airflow is far from a center of the optical disk. Thus, the flow noise due to the rotation of the disk can be reduced.

In the context of this specification, “circumferential periphery” is used to describe that the wall is formed at the periphery of the other side of the chucking pulley so as to prevent the acceleration of the airflow caused by the centrifugal force due to the rotation of the optical disk. For example, the wall may be formed as an integral circular structure at the whole periphery of the chucking pulley, as shown in FIGS. 1, 2A and 2B. Alternatively, the wall may be composed of a series of sub-walls that are intermittently arranged at given intervals on the periphery of the pulley.

The disk chucking device may be configured so that the above chucking pulley has a plurality of walls and that the plurality of the walls are concentrically located and radially separated from each other by a certain space. With this structure, since the plurality of the walls are concentrically located and radially separated from each other by the space, the disk chucking device can prevent the increasing acceleration of the airflow due to the rotation of the optical disk. Thus the flow rate can be decreased and the flow noise due to the rotation of the disk can be reduced.

The above disk chucking device may be configured so that the chucking pulley has a resonance frequency higher than that of the optical disk to be attached thereto. Thus, the disk chucking device can prevent the optical disk from being deformed due to resonance generated by the rotation of the optical disk.

The disk chucking device may be configured so that the chucking pulley has a profile that is higher at a center portion than the other portions on the side where the wall is located. Thus increased thickness of the chucking pulley can enhance the rigidity of the chucking pulley.

The disk chucking device may be configured so that the pressure contacting surface of the chucking pulley is formed to have a diameter greater than that of the reference surface of the turn table. The increased diameter of the pressure contacting surface of the chucking pulley can enhance the rigidity of the chucking pulley, and thus reducing deformation of the optical disk. The reduced deformation of the optical disk contributes to reducing stress generated by the deformation. Thus the optical disk can be prevented from being broken while the optical disk is used in its resonance frequency region.

The above disk chucking device may be configured so that the pressure contacting surface of the chucking pulley is formed to have a diameter equal to that of the optical disk to be attached thereto. Since the diameter of the chucking pulley of the disk chucking device is equal to that of the optical disk, an area at which the chucking pulley comes into pressure contact with the disk is expanded so that it is ensured that the optical disk can be prevented from vibrating at its resonance frequency when the optical disk rotates.

The above objects of the present invention are also achieved by a disk chucking device for an optical disk drive, the disk chucking device comprising: a turn table that is rotated by a spindle motor; and a chucking pulley that has a pressure contacting surface on one side of the chucking pulley, the pressure contacting surface forcing an optical disk to come into pressure contact with a reference surface of the turn table, the chucking pulley comprising means for preventing acceleration of airflow caused by centrifugal force due to rotation of the optical disk.

The above objects of the present invention are achieved by an optical disk drive in which the optical disk drive includes the disk chucking device mentioned above.

The disk chucking device for the optical disk driver may be configured so that the chucking pulley has at least one wall that is provided on the other side of the chucking pulley and is arranged along a circumferential periphery of the chucking pulley. The wall functions to prevent acceleration of the airflow caused by the centrifugal force due to the rotation of the optical disk. Since the wall can intercept the airflow and stop the acceleration of the airflow, otherwise the flow rate thereof would be accelerated as the airflow is far from the center of the optical disk. Therefore, the optical disk drive is provided in which the reduced flow rate enables to reduce the flow noise due to the rotation of the disk.

### BRIEF DESCRIPTION OF THE DRAWINGS

Other objects, features and advantages of the present invention will become more apparent from the following detailed description when read in conjunction with the accompanying drawings, in which:

FIG. 1 is a schematic diagram of a disk chucking device for an optical disk drive according to a first embodiment of the present invention;

FIG. 2A is a front view of a chucking pulley of the disk chucking device shown in FIG. 1;

FIG. 2B is a plan view of the chucking pulley of the disk chucking device shown in FIG. 1;

FIG. 3 is a schematic diagram of a disk chucking device for an optical disk drive according to a second embodiment of the present invention;

FIG. 4A is a front view of a chucking pulley of the disk chucking device shown in FIG. 3;

FIG. 4B is a plan view of the chucking pulley of the disk chucking device shown in FIG. 3;

FIG. 5 is a schematic diagram of a disk chucking device for an optical disk drive according to a third embodiment of the present invention;

FIG. 6A is a front view of a chucking pulley of the disk chucking device shown in FIG. 5;

FIG. 6B is a plan view of the chucking pulley of the disk chucking device shown in FIG. 3;

FIG. 7 is a schematic diagram of a disk chucking device for an optical disk drive according to a fourth embodiment of the present invention;

FIG. 8A is a front view of a chucking pulley of the disk chucking device shown in FIG. 7;

FIG. 8B is a plan view of the chucking pulley of the disk chucking device shown in FIG. 7;

FIG. 9 is a schematic diagram of a disk chucking device for an optical disk drive according to a fifth embodiment of the present invention;

FIG. 10 is a perspective view of a conventional optical disk drive in unloading state;

FIG. 11 is a perspective view of the conventional optical disk drive in loading state;

FIG. 12 illustrates a first example of a conventional disk chucking device for an optical disk drive;

FIG. 13 illustrates a second example of a conventional disk chucking device for an optical disk drive; and

FIG. 14 shows how flow noise is generated in the conventional disk chucking device.

### DESCRIPTION OF THE PREFERRED EMBODIMENTS

A description will be given of preferred airflow caused by centrifugal force due to rotation of the optical disk 1. The wall 164 serves as means for preventing acceleration of airflow caused by centrifugal force due to rotation of the optical disk 1. Preferably, the chucking pulley 163 is made of lightweight material and is designed to be highly rigid. For example, lightweight resin, lightweight metal, carbon group and so on may be used as the lightweight material. The wall 164 may be formed integrally with the chucking pulley 163.

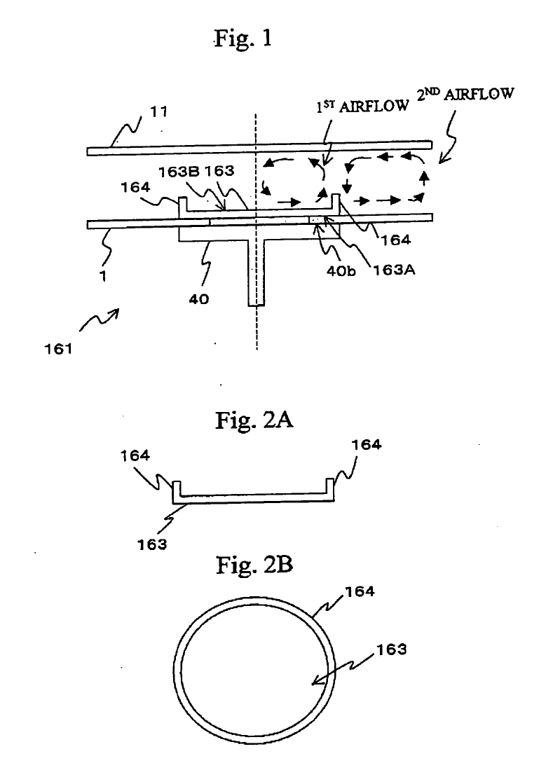

In this manner, the disk chucking device 161 is provided with the wall 164 peripherally and circularly on the other side 163B of the chucking pulley 163 to prevent the acceleration of the airflow caused by the centrifugal force due to the rotation of the optical disk 1. As a result, the wall 164 intercepts the airflow shown in FIG. 14 and divides the airflow into first airflow and second airflow as shown in FIG. 1. Therefore, the disk chucking device 161 can stop the acceleration of the airflow, otherwise the flow rate thereof would be accelerated as the airflow is far from a center of the optical disk 1. Thus reduced flow rate can reduce the flow noise due to the rotation of the optical disk 1. Furthermore, it is preferable that the chucking pulley 163 has a resonance frequency higher than that of the optical disk 1 to be attached thereto so that the disk chucking device 163 can suppress the resonance of the optical disk 1 and prevent the optical disk 1 from being deformed due to the resonance generated by the rotation of the optical disk 1. This is because the optical disk 1 can be protected from fatigue failure according to the first embodiment of the present invention.

Second Embodiment

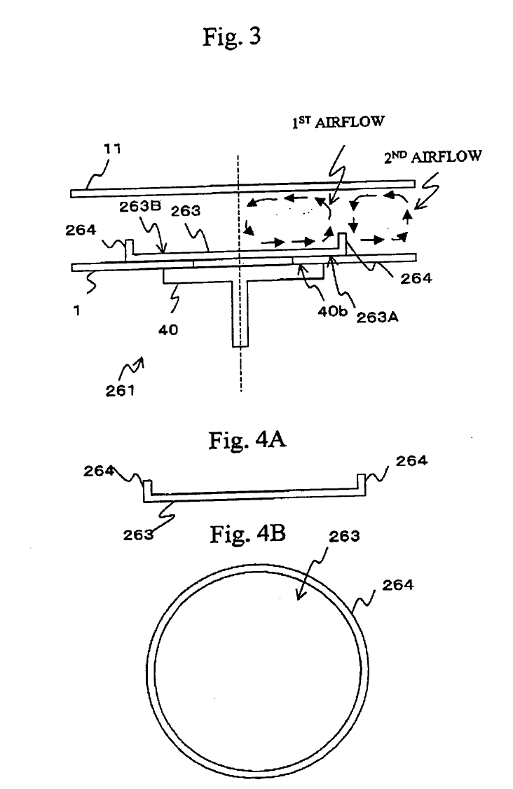

FIG. 3 illustrates a disk chucking device 261 for an optical disk drive according to a second embodiment of the present invention. FIGS. 4A and 4B are front and plan views of a chucking pulley 263 of the disk chucking device 261 shown in FIG. 3, respectively.

Referring to FIGS. 3, 4A and 4B, the disk chucking device 261 for the optical disk includes a turn table 40 that is rotated by a spindle motor (not shown in FIG. 3). The disk chucking device 261 also includes a chucking pulley 263 that is magnetically attracted by the turn table 40. The chucking pulley 263 has a pressure contacting surface 263A on one side of the chucking pulley 263. The pressure contacting surface 263A forces an optical disk 1 to come into pressure contact with a reference surface for disk attachment 40b of the turn table 40 and attaches the optical disk 1 to the reference surface 40b.

The chucking pulley also has a wall 264, which is provided on the other side 263B of the chucking pulley 263 and is arranged along the circumferential periphery of the chucking pulley 264. The wall 264 is capable of preventing acceleration of airflow caused by centrifugal force due to rotation of the optical disk 1. In the second embodiment, the disk chucking device 261 differs from the disk chucking device 161 of the above first embodiment in that the pressure contacting surface 263A of the chucking pulley 263 is formed to have a diameter greater than that of the reference surface 40b of the turn table. Preferably, the chucking pulley 263 is made of lightweight material and designed to be highly rigid. For example, lightweight resin, lightweight metal, carbon group and so on may be used as the lightweight material. The wall 264 may be formed integrally with the chucking pulley 263.

In this manner, the disk chucking device 261 is provided with the wall 264 peripherally and circularly on the other side 263B of the chucking pulley 263 to prevent the acceleration of the airflow caused by the centrifugal force due to the rotation of the optical disk 1. As a result, the wall 264 intercepts the airflow shown in FIG. 14 and divides the airflow into first airflow and second airflow as shown in FIG. 3. Therefore, the disk chucking device 261 can stop the acceleration of the airflow, otherwise the flow rate thereof would be accelerated as the airflow is far from a center of the optical disk 1. Thus reduced flow rate can reduce the flow noise due to the rotation of the optical disk 1.

In addition to a provision of the wall 264, the disk chucking device 261 according to the second embodiment of the present invention is configured such that the pressure contacting surface 263A of the chucking pulley 263 is formed to have the diameter greater than that of the reference surface 40b of the turn table 40. The increased diameter of the pressure contacting surface 263A can enhance the rigidity of the chucking pulley 263, and thus reducing deformation of the optical disk 1. The reduced deformation of the optical disk 1 contributes to reducing stress generated by the deformation of the optical disk 1. Thus the optical disk can be prevented from being broken while the optical disk is used in its resonance frequency region. Furthermore, it is preferable that the chucking pulley 263 has a resonance frequency higher than that of the optical disk 1 to be attached thereto so that the disk chucking device 263 can suppress the resonance of the optical disk 1 and prevent the optical disk 1 from being deformed due to the resonance generated by the rotation of the optical disk 1. This is because the optical disk 1 can be protected from fatigue failure in the second embodiment of the present invention.

Third Embodiment

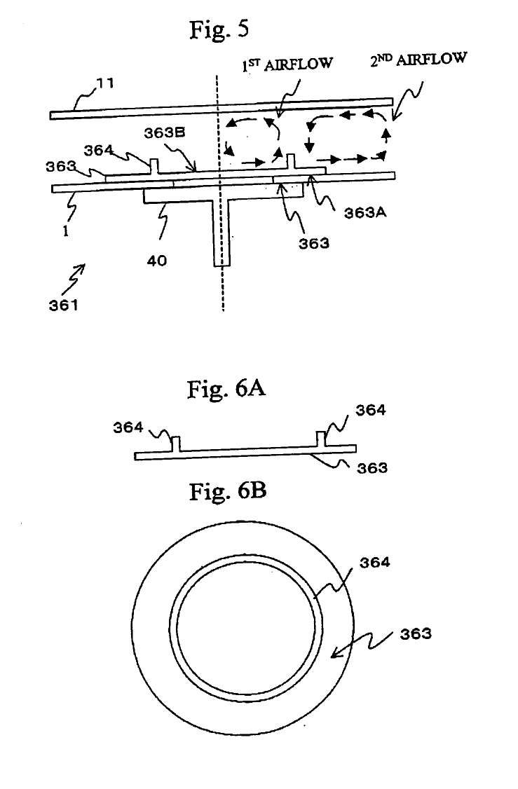

FIG. 5 illustrates a disk chucking device 361 for an optical disk drive according to a third embodiment of the present invention. FIGS. 6A and 6B are front and plan views of a chucking pulley 363 of the disk chucking device 361 shown in FIG. 5, respectively.

Referring to FIGS. 5, 6A and 6B, the disk chucking device 361 for the optical disk includes a turn table 40 that is rotated by a spindle motor (not shown in FIG. 5). The disk chucking device 361 also includes a chucking pulley 363 that is magnetically attracted by the turn table 40. The chucking pulley 363 has a pressure contacting surface 363A on one side of the chucking pulley 363. The pressure contacting surface 363A forces the optical disk 1 to come into pressure contact with a reference surface for disk attachment 40b of the turn table 40 and attaches the optical disk 1 to the reference surface 40b.

The chucking pulley also has a wall 364 peripherally and circularly on the other side 363D of the chucking pulley 363. The wall 364 is capable of preventing acceleration of airflow caused by centrifugal force due to rotation of the optical disk 1.

In the above first and second embodiments, the walls 164 and 264 are provided at the respective edges of the chucking pulleys 163 and 263, respectively. However, in the third embodiment, the wall 364 may be provided at a position apart from the center of the chucking pulley 363 by a certain distance, as shown in FIGS. 5, 6A and 6B, although the wall 364 is arranged along the circumferential periphery of the chucking pulley 363. Similar to the second embodiment, the disk chucking device 361 according to the third embodiment is configured so that the pressure contacting surface 363A of the chucking pulley 363 is formed to have a diameter greater than that of the reference surface 40b of the turn table 40. Preferably, the chucking pulley 363 is made of lightweight material and designed to be highly rigid. For example, lightweight resin, lightweight metal, carbon group and so on may be used as the lightweight material. The wall 364 may be formed integrally with the chucking pulley 363.

In this manner, the disk chucking device 361 is provided with the wall 364 peripherally and circularly on the other side 363B of the chucking pulley 363 to prevent the acceleration of the airflow caused by the centrifugal force due to the rotation of the optical disk 1. As a result, the wall 364 intercepts the airflow shown in FIG. 14 and divides the airflow into first airflow and second airflow as shown in FIG. 5. Therefore, the disk chucking device 361 can stop the acceleration of the airflow, otherwise the flow rate thereof would be accelerated as the airflow is far from a center of the optical disk 1. Thus reduced flow rate can reduce the flow noise due to the rotation of the optical disk 1.

In addition to a provision of the wall 364, the disk chucking device 361 according to the third embodiment of the present invention is configured such that the pressure contacting surface 363A of the chucking pulley 363 is formed to have the diameter greater than that of the reference surface 40b of the turn table 40. The increased diameter of the pressure contacting surface 363A can enhance the rigidity of the chucking pulley 363, and thus reducing deformation of the optical disk 1. The reduced deformation of the optical disk 1 contributes to reducing stress generated by the deformation of the optical disk 1. Thus the optical disk 1 can be prevented from being broken while the optical disk is used in its resonance frequency region. Furthermore, it is preferable that the chucking pulley 363 has a resonance frequency higher than that of the optical disk 1 to be attached thereto so that the disk chucking device 363 can suppress the resonance of the optical disk 1 and prevent the optical disk 1 from being deformed due to the resonance generated by the rotation of the optical disk 1. This is because the optical disk 1 can be protected from fatigue failure in the third embodiment of the present invention.

Fourth Embodiment

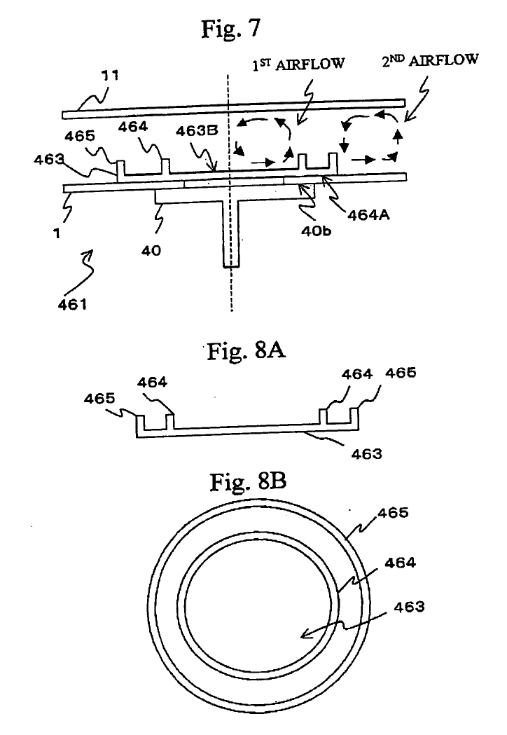

FIG. 7 illustrates a disk chucking device 461 for an optical disk drive according to a fourth embodiment of the present invention. FIGS. 8A and 8B are front and plan views of a chucking pulley 463 of the disk chucking device 461 shown in FIG. 7, respectively.

Referring to FIGS. 7, 8A and 8B, the disk chucking device 461 for the optical disk includes a turn table 40 that is rotated by a spindle motor (not shown in FIG. 7). The disk chucking device 461 also includes a chucking pulley 463 that is magnetically attracted by the turn table 40. The chucking pulley 463 has a pressure contacting surface 463A on one side of the chucking pulley 463. The pressure contacting surface 463A forces the optical disk 1 to come into pressure contact with a reference surface for disk attachment 40b of the turn table 40 and attaches the optical disk 1 to the reference surface 40b.

The chucking pulley also has wall 464 and 465, which are on the other side 463B of the chucking pulley 463 and are arranged along the circumferential periphery of the chucking pulley 463. The walls 464 and 465 are capable of preventing an acceleration of airflow caused by centrifugal force due to rotation of the optical disk 1.

In the above embodiments, each of the chucking pulleys 163, 263 and 363 is provided with one layer of the wall. However in the fourth embodiment, the chucking pulley 463 has two layers of the walls 464 and 465 that are concentrically located and radially separated from each other. It should be noted that the number of layers may be more than two.

Similar to the second embodiment, the disk chucking device 461 according to the fourth embodiment is configured so that the pressure contacting surface 463A of the chucking pulley 463 is formed to have a diameter greater than that of the reference surface 40b of the turn table 40. Preferably, the chucking pulley 463 is made of lightweight material and designed to be highly rigid. For example, lightweight resin, lightweight metal, carbon group and so on may be used as the lightweight material. The walls 464 and 465 may be formed integrally with the chucking pulley 463.

In this manner, the disk chucking device 461 is provided with the walls 464 and 465 peripherally and circularly on the other side 463B of the chucking pulley 463 to prevent the acceleration of the airflow caused by the centrifugal force due to the rotation of the optical disk 1. As a result, the walls 464 and 465 intercept the airflow shown in FIG. 14 and divide the airflow into first airflow and second airflow as shown in FIG. 7. Therefore, the disk chucking device 461 can stop the acceleration of the airflow, otherwise the flow rate thereof would be accelerated as the airflow is far from a center of the optical disk 1. Thus, the reduced flow rate can reduce the flow noise due to the rotation of the optical disk 1. Furthermore, in this embodiment, since the walls 464 and 465 are concentrically located on the chucking pulley 463 and radially separated from each other by a certain space, the disk chucking device 464 can further prevent the increasing acceleration of the airflow due to the rotation of the optical disk 1.

In addition to a provision of the walls 464 and 465, the disk chucking device 461 according to the fourth embodiment of the present invention is configured such that the pressure contacting surface 463A of the chucking pulley 463 is formed to have the diameter greater than that of the reference surface 40b of the turn table 40. The increased diameter of the pressure contacting surface 463A can enhance the rigidity of the chucking pulley 463, and thus reducing deformation of the optical disk 1. The reduced deformation of the optical disk 1 contributes to reducing stress generated by the deformation of the optical disk 1. Thus the optical disk 1 can be prevented from being broken while the optical disk is used in its resonance frequency region. Furthermore, it is preferable that the chucking pulley 463 has a resonance frequency higher than that of the optical disk 1 to be attached thereto so that the disk chucking device 463 can suppress the resonance of the optical disk 1 and prevent the optical disk 1 from being deformed due to the resonance generated by the rotation of the optical disk 1. This is because the optical disk 1 can be protected from fatigue failure in the fourth embodiment of the present invention.

Fifth Embodiment

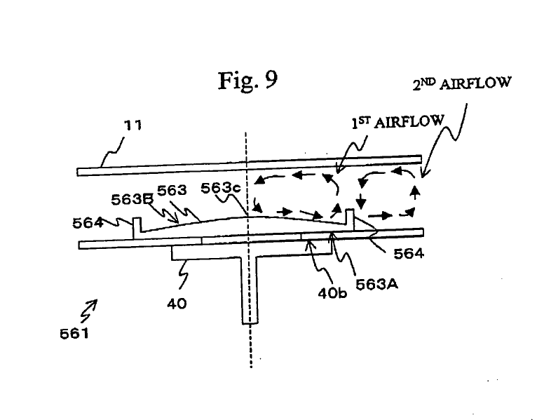

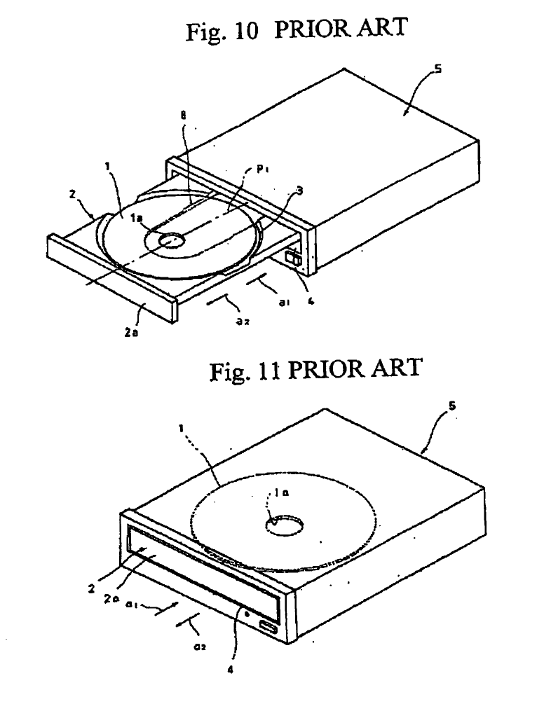

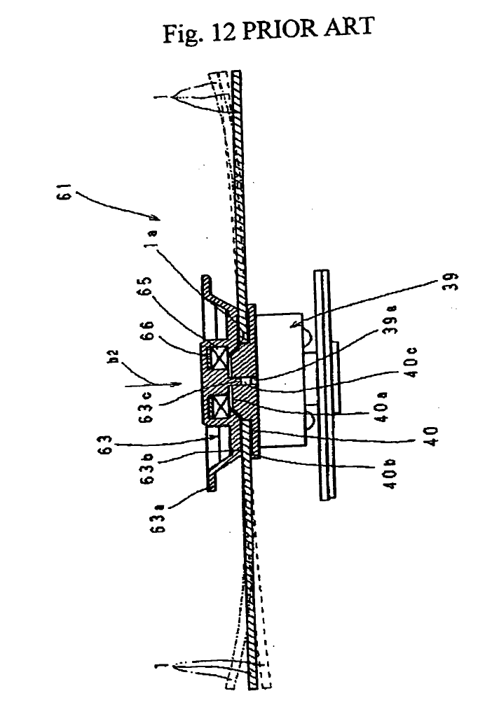

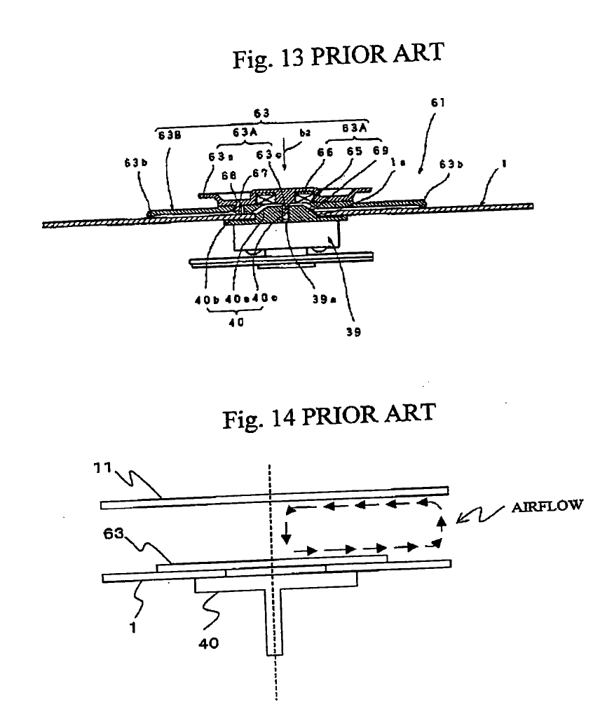

FIG. 9 illustrates a disk chucking device 561 for an optical disk drive according to a fifth embodiment of the present invention. As shown in FIG. 9, the disk chucking device 561 for the optical disk includes a turn table 40 that is rotated by a spindle motor (not shown in FIG. 9). The disk chucking device 561 also includes a chucking pulley 463 that is magnetically attracted by the turn table 40. The chucking pulley 563 has a pressure contacting surface 563A on one side of the chucking pulley 563. The pressure contacting surface 563A forces the optical disk 1 to come into pressure contact with a reference surface for disk attachment 40b of the turn table 40 and attaches the optical disk 1 to the reference surface 40b.

The chucking pulley 563 also has a wall 564 peripherally and circularly on the other side 563B of the chucking pulley 563. The wall 564 is capable of preventing acceleration of airflow caused by centrifugal force due to rotation of the optical disk 1.

According to the fifth embodiment of the present invention, the chucking pulley 563 is formed to have a profile that is higher at a center portion than the other portions on the side 563B where the wall 564 is located. In addition, similar to the second embodiment, the pressure contacting surface 563A of the chucking pulley 563 is formed to have a diameter greater than that of the reference surface 40b of the turn table 40. Preferably, the chucking pulley 563 is made of lightweight material and designed to be highly rigid. For example, aluminum, carbon material and so on may be used as the lightweight material. The wall 564 may be formed integrally with the chucking pulley 563.

In this manner, the disk chucking device 561 is provided with the wall 564 peripherally and circularly on the other side 563B of the chucking pulley 563 to prevent the acceleration of the airflow caused by the centrifugal force due to the rotation of the optical disk 1. As a result, the wall 564 intercepts the airflow shown in FIG. 14 and divides the airflow into first airflow and second airflow as shown in FIG. 9. Therefore, the disk chucking device 361 can stop the acceleration of the airflow, otherwise the flow rate thereof would be accelerated as the airflow is far from a center of the optical disk 1. Thus reduced flow rate can reduce the flow noise due to the rotation of the optical disk 1.

According to this embodiment, since the chucking pulley 563 is formed to have the profile that is higher at the center portion than the other portions on the side 563B where the wall 564 is located, this increased thickness of the chucking pulley 563 can enhance the rigidity of the chucking pulley 563. Moreover, the disk chucking device 561 according to the fifth embodiment of the present invention is configured such that the pressure contacting surface 563A of the chucking pulley 563 has the diameter greater than that of the reference surface 40b of the turn table 40. This increased diameter of the pressure contacting surface 563A can further enhance the rigidity of the chucking pulley 563, and thus reducing deformation of the optical disk 1. The reduced deformation of the optical disk 1 contributes to reducing stress generated by the deformation of the optical disk 1. Thus the optical disk 1 can be prevented from being broken while the optical disk is used in its resonance frequency region. Furthermore, it is preferable that the chucking pulley 563 has a resonance frequency higher than that of the optical disk 1 to be attached thereto so that the disk chucking device 563 can suppress the resonance of the optical disk 1 and prevent the optical disk 1 from being deformed due to the resonance generated by the rotation of the optical disk 1. This is because the optical disk 1 can be protected from fatigue failure in the fifth embodiment of the present invention.

The present invention is not limited to the specifically disclosed embodiments, and variations and modifications may be made without departing from the scope of the present invention mentioned before.

The disk chucking device according to the present invention is provided with the wall peripherally on the backside of the pressure contacting surface coming into pressure contact with the optical disk. This simple structure effectively reduces the flow noise due to the rotation of the optical disk.

The present invention is based on Japanese Patent Application No. 2002-318363, the entire disclosure of which is hereby incorporated by reference.

What is claimed is:

1. A disk chucking device for an optical disk drive, the disk chucking device comprising:
a turn table that is rotated by a spindle motor; and
a chucking pulley that has a pressure contacting surface on one side of the chucking pulley, the pressure contacting surface forcing an optical disk to come into pressure contact with and attaching the optical disk to a reference surface of the turn table,
wherein the chucking pulley has at least one wall that is provided on the other side of the chucking pulley and is arranged along a circumferential periphery of the chucking pulley.

2. The disk chucking device as claimed in claim 1,
wherein the chucking pulley has a plurality of walls and the plurality of the walls are concentrically located and are radially separated from each other by a certain space.

3. The disk chucking device claimed in claim 1,
wherein the chucking pulley has a resonance frequency that is higher than that of the optical disk.

4. The disk chucking device claimed in claim 1,
wherein the chucking pulley has a profile that is higher at a center portion thereof than other portions on the other side where the wall is located.

5. The disk chucking device claimed in claim 1,
wherein the pressure contacting surface of the chucking pulley is formed to have a diameter greater than that of the reference surface of the turn table.

6. The disk chucking device claimed in claim 1,
wherein the pressure contacting surface of the chucking pulley is formed to have a diameter equal to that of the optical disk.

7. A disk chucking device for an optical disk drive, the disk chucking device comprising:
a turn table that is rotated by a spindle motor; and
a chucking pulley that has a pressure contacting surface on one side of the chucking pulley, the pressure contacting surface forcing an optical disk to come into pressure contact with a reference surface of the turn table,
the chucking pulley comprising means for preventing acceleration of airflow caused by centrifugal force due to rotation of the optical disk.

8. An optical disk drive including a disk chucking device comprising:
a turn table that is rotated by a spindle motor; and
a chucking pulley that has a pressure contacting surface on one side of the chucking pulley, the pressure contacting surface forcing an optical disk to come into pressure contact with and attaching the optical disk to a reference surface of the turn table,
wherein the chucking pulley has at least one wall that is provided on the other side of the chucking pulley and is arranged along a circumferential periphery of the chucking pulley.
